(19) United States
(12) Patent Application Publication
(10) Pub. No.: US 2003/0036584 A1
(43) Pub. Date: Feb. 20, 2003

(54) Pigment dispersant for cathodic electrocoating compositions

(76) Inventor: Allisa Gam, Troy, MI (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 09/924,760

(22) Filed: Aug. 8, 2001

(51) Int. Cl. C03C 17/00; C09D 5/00; C08G 69/08; C08G 73/10; C08G 63/00

(52) U.S. Cl. 523/160; 523/161; 528/310; 528/332; 528/365

(57) ABSTRACT

A pigment dispersant that is useful in a cathodic electrocoating composition that is the reaction product of (1) an adduct of an alkyl aminoalkyl amine and an alkylene carbonate; (2) an organic acid to form a tertiary amine salt and (3) an epoxy resin that is reacted with the tertiary amine salt to form a quaternary ammonium salt.

### BACKGROUND OF THE INVENTION

1. Field of the Invention

This invention is directed to a pigment dispersant and in particular to a pigment dispersant that is useful in a cathodic electrocoating composition.

2. Description of the Prior Art

Coating of electrically conductive substrates by an electrodeposition process (also called an electrocoating process) is well known and an important industrial process used particularly in the manufacture of automobiles and trucks. In the electrodeposition of primers, an article, such as, an auto body or truck body or parts for autos and trucks, is immersed in an aqueous electrocoating bath of an electrocoating composition that contains an aqueous emulsion of a film forming polymer and the article acts as an electrode. An electrical current is passed between the article and a counter electrode in contact with the aqueous emulsion until a coating is deposited having the desired thickness. In a cathodic electrocoating process the article to be coated is the cathode and the counter electrode is the anode. The article to be coated is passed through the bath for a period of time (time in the bath controls the thickness of the coating that is deposited) and then the coated article is removed from the bath, rinsed with water and then baked to form a primer coating on the article.

The aqueous emulsions of film forming polymer used in cathodic electrocoating process also are well known. The film forming polymer typically is a polyepoxide that has been chain extended and formed into an adduct having amine groups and neutralized with an acid and blended with a crosslinking agent, such as, a blocked polyisocyanate crosslinking agent. The aqueous electrocoating bath contains the film forming polymer, a crosslinking agent, a pigment paste or a pigment dispersion, coalescing solvents and other additives.

There continues to be a problem with keeping pigments adequately dispersed in the electrocoating bath particularly, lead free pigments that are currently being used and maximizing the pigment to binder weight ratio and reducing the VOC (volatile organic content) of the bath. Novel pigment dispersants have been developed for electrocoating compositions, as shown in Peng, U.S. Pat. No. 4,946,507 issued Aug. 7, 1990, Gebregiorgis, U.S. Pat. No. 5,116,903 issued May 26, 1992 and Gebregiorgis, U.S. Pat. No. 5,324,756 issued Jun. 28, 1994 but do not adequately solve the aforementioned problems. The novel pigment dispersant of this invention provides improved dispersion of lead free pigments and a maximum pigment to binder ratios in the electrocoating bath and allows for the reduction of VOCs in the bath to meet current regulatory requirements.

### SUMMARY OF THE INVENTION

A pigment dispersant that is useful in a cathodic electrocoating composition is the reaction product of (1) an adduct of an alkyl aminoalkyl amine and an alkylene carbonate; (2) an organic acid that forms a tertiary amine salt and (3) an epoxy resin that is reacted with the tertiary amine salt to form a quaternary ammonium salt.

A cathodic electrocoating composition that utilizes the novel pigment dispersant also is part of this invention.

### DETAILED DESCRIPTION OF THE INVENTION

A typical auto or truck body is produced from a steel sheet or a plastic or a composite substrate. If steel is used, it is first treated with an inorganic rust-proofing compound, such as, zinc or iron phosphate and then a primer coating is applied generally by electrodeposition. Typically, these electrodeposition primers are epoxy modified resins crosslinked with a polyisocyanate and are applied by a cathodic electrodeposition process. Optionally, a primer can be applied over the electrodeposited primer, usually by spraying, to provide better appearance and/or improved adhesion of a base coating or a mono coating to the primer. A mono coating of a pigmented coating composition then can be applied but preferably, a pigmented base coating and a clear top coating are then applied. Usually, each of the coatings after application are cured by baking at elevated temperatures. It is generally known that a clear top coating can be applied over the base coating and both coatings cured together at an elevated temperature.

There are several advantages of the novel cathodic electrocoating composition formulated with the novel pigment dispersant of this invention. (1) Electrocoating bath formulated with the novel pigment dispersant have a low VOC, i.e., a VOC less than 0.03 kg/l (0.25 pounds per gallon). (2) The electrocoating compositions meet current governmental air pollution regulations and (3) foam is not generated during the pigment grinding process. The low VOC of the composition is accomplished by: (1) forming the novel pigment dispersent with less solvent in the synthesis process and (2) formulating pigment paste with a high pigment to binder ratio due to high pigment wefting property of the novel pigment dispersant. Prior art compositions achieve low VOC by using low molecular weight surfactants as their main components, which cause severe foaming during the pigment grinding process.

The VOC of the coating composition is determined in accordance with the procedure of EPA Method 24.

The novel pigment dispersant is the reaction product of an adduct of an alkyl aminoalkyl amine and an alkylene carbonate, an organic acid that forms a tertiary amine salt and an epoxy resin that is reacted with the amine salt to form a quaternary ammonium salt.

The adduct of an alkyl aminoalkyl amine and an alkylene carbonate is formed by charging the constituents into a reaction vessel, preferably, under an inert atmosphere, such as, nitrogen, and reacting at a temperature of about 75-110° C. for about 30 to 180 minutes. Generally, an equal molar amount of amine to carbonate is used, however, a slight excess of carbonate is acceptable.

Typical alkyl amino alkyl amines that are used are dimethylaminopropylamine, diethylaminopropylamine, diethanolaminopropylamine, dimethanolaminopropylamine and morpholinepropylamine. The preferred amine is dimethylaminopropylamine since it forms a superior pigment dispersant.

Typical alkylene carbonates that can be used have 2-4 carbon atoms in the alkylene group and are ethylene carbonate, propylene carbonate, isopropylene carbonate, butylene carbonate and isobutylene carbonate. Preferred are five or six membered ring carbonates. Propylene carbonate is particularly preferred.

The adduct then is reacted with an acid to form a tertiary amine salt. Typically, the organic acid is slowly added to the adduct and held at a temperature of about 75-115° C. for about 30-180 minutes to form the amine salt. Sufficient acid is added to neutralize all amine groups.

Typical acids that can be used are organic acids like, lactic acid, acetic acid, and formic acid, and other acids, like, phosphoric acid, sulfamic acid and sulfonic acid.

The above tertiary amine salt is reacted with an epoxy resin to form quaternary ammonium salt. The epoxy resin in solution is added to the tertiary amine salt held at a temperature of about 75-115° C. for about 30-180 minutes to form the quaternary ammonium salt. Typically, the epoxy resin is added as a solution in a solvent, such as, mono methyl ether of propylene glycol. However, less solvent is needed in comparison to conventional resin synthesis processes.

Typical epoxy resins that are used have an epoxide equivalent weight of about 100-1,000. Typically useful epoxy resins are epoxy resins of diglycidyl ether and bisphenol A, such as, Epon® 828, Epon® 1001 and Epon®1002F having epoxy equivalent weight of 188, 500 and 650 respectively. Other epoxy resins that can be used are aliphatic epoxy resins, such as, neopentyl glycol diglycidyl ether, 1,4 butanediol diglycidyl ether, 1,4 cyclohexanedimethanol diglycidyl ether, hydrogenated bisphenol A diglycidyl ether.

The novel pigment dispersant is used to form a pigment paste that is then blended with the other components of a typical cathodic electrocoating composition, such as, the principal emulsion, which is a blend of a cationic epoxy amine adduct and a crosslinking agent, coalescing solvents, water and other additives. The pigment paste is prepared by grinding or dispersing a pigment in the pigment dispersant; optionally, other ingredients are added, such as, wetting agents, surfactants, and defoamers. After grinding, the particle size of the pigment paste or dispersion is about 6-8, determined by using a Hegman grinding gauge. The pigment paste or dispersant generally is used in amounts of 1-15% by weight, based on the weight of the binder of the electrocoating composition.

Typical pigments that are used in cathodic electrocoating compositions include titanium dioxide, carbon black, iron oxide, clay and the like. Pigments with high surface areas and oil absorbencies should be used judiciously because they can have an undesirable affect on coalescence and flow of the electrodeposited coating.

Typical principal emulsions used in cathodic electrocoating compositions comprise an aqueous emulsion of an epoxy amine adduct that has been neutralized with an acid to form a water soluble or water dispersible product and is blended with a crosslinking agent. Generally a catalyst is added to the electrocoating composition.

Useful epoxy amine adducts are generally disclosed in U.S. Pat. No. 4,419,467 which is incorporated herein by reference.

Preferred crosslinking agents are those well known in the art, such as, aliphatic, cycloaliphatic and aromatic polyisocyanates, such as, hexamethylene diisocyanate, cyclohexamethylene diisocyanate, toluene diisocyanate, metheylene diphenyl diisocyanate and the like. The isocyanates are prereacted with blocking agents, such as, oximes, alcohols, or caprolactams that block the isocyanate functionality, the crosslinking functionality. Upon heating the electrodeposited composition after it has been deposited on a substrate, the blocking agent separates thereby providing a reactive isocyanate group and crosslinking of the composition occurs. Isocyanate crosslinking agents and blocking agents are well known in the art and are disclosed in the aforementioned U.S. Pat. No. 4,419,467.

The cathodic electrocoating composition of this invention can contain optional ingredients, such as, wetting agents, surfactants, and defoamers. Examples of surfactants and wetting agents include, alkyl imidazoles and acetylenic alcohols. These optional ingredients, when present, constitute 0.1 to 2.0 percent by weight of the binder solids of the composition.

Optionally, plasticizers can be used to promote flow. Examples of useful plasticizers are high boiling water immiscible materials, such as, ethylene or propylene oxide adducts of nonyl phenols of bisphenol A. Plasticizers are usually used at levels of 0.1 to 15% by weight, based on binder solids.

The electrocoating composition is an aqueous dispersion. The term “dispersion” as used within this context is believed to be a two-phase translucent or opaque aqueous resinous binder system in which the binder is in the dispersed phase and water in the continuous phase. The average particle size diameter of the binder phase is about 0.1 to 10 microns, preferably, less than 5 microns. The concentration of the binder in the aqueous medium is not critical but ordinarily the major portion of the aqueous dispersion is water. The aqueous dispersion usually contains about 3 to 50%, preferably, 5 to 40% by weight binder solids. Concentrates of the composition that are shipped to a manufacturing site are diluted with water to provide an electrocoating bath having a binder solids content in the range of 10 to 30% by weight.

Besides water the aqueous medium of the cathodic electrocoating composition contains coalescing solvent(s). Useful coalescing solvents include hydrocarbons, alcohols, polyols and ketones. Preferred coalescing solvents include monbutyl and monhexyl ethers of etheylene glycol and phenyl ether of propylene glycol. The amount of coalescing solvent is not unduly critical and is generally between 0.1 to 15 % by weight, preferably 0.5 to 5% by weight, based on total weight of binder solids in the composition.

The conditions under which electrodeposition is carried are similar to those typically used in a cathodic electrodeposition process. The applied voltage typically is between 50 and 500 volts and the current density is between 0.5 and 15 amperes per square foot and tend to decrease during electodeposition as an insulating film is formed. Typically, the composition is cured by baking at an elevated temperature of 90 to 260° C. for about 5 to 30 minutes.

The following examples illustrate the invention. All parts and percentages unless otherwise indicated are on a weight basis. The examples disclose the preparation of the novel pigment dispersant, a pigment paste made from the dispersant and a cathodic electrocoating composition made from the pigment paste and a typical cathodic binder.

### EXAMPLE1

### Preparation of A Novel Pigment Dispersant

A pigment dispersant was prepared by charging 315 parts of dimethylaminopropylamine into a reaction vessel and the amine was heated to 82° C. under a dry nitrogen blanket. 315 parts of propylene carbonate was slowly charged into the reaction vessel while maintaining the reaction temperature below 115° C. The resulting reaction mixture was held at 110° C. for at least one hour. 315 parts of lactic acid solution (88% in water) was slowly charged in to the reaction vessel while maintaining the temperature below 110C. The reaction mixture was then held at 110C for one hour. 2545 parts epoxy resin solution (75% solids in propylene glycol mono methyl of diglycidyl ether of bishpenol A having an epoxy equivalent weight of 550) was charged into the reaction vessel and the reaction vessel and held at 110° C. for several hours until the acid number below 0.8 was reached. 544 parts deionized water then was added to the reaction mixture. The resulting reaction mixture had a nonvolatile content of 65%, 14.47% solvent (propylene glycol mono methyl ether) and 20.53% deionized water.

### Preparation of Conventional Quaternizing Agent

The quaternizing agent was prepared by adding 87 parts dimethylethanolamine to 320 parts 2-ethyl hexanol half-capped toluene diisocyanate in the reaction vessel at room temperature. An exothermic reaction occurred and the reaction mixture was stirred for one hour at 80° C. 118 parts aqueous lactic acid solution (75% nonvolatile content) was then added followed by the addition of 39 parts 2-butoxyethanol. The reaction mixture was held for about one hour at 65° C. with constant stirring to form the quaternizing agent.

### Preparation of Conventional Pigment Dispersant

The pigment grinding vehicle was prepared by charging 710 parts Epon 828 (diglycidyl ether of bisphenol A having an epoxide equivalent weight of 188) and 290 parts bisphenol A into a suitable vessel under nitrogen blanket and heated to 150° C.-160° C. to initiate an exothermic reaction. The exothermic reaction was continued for about one hour at 150° C.-160° C. The reaction mixture was then cooled to 120° C. and 496 parts of 2-ethyl hexanol half-capped toluene diisocyanate was added. The temperature of the reaction mixture was held at 110° C.-120° C. for one hour, followed by the addition of 1095 parts of 2-butoxyethanol, the reaction mixture was then cooled to 85° C.-90° C. and then 71 parts of deionized water was added followed by the addition of 496 parts quaternizing agent (prepared above). The temperature of the reaction mixture was held at 85° C.-90° C. until an acid value of about 1 was obtained. The resulting reaction mixture had a nonvolatile content of 58%, 39% solvent (ethylene glycol mono butyl ether) and 3% deionized water,

### Preparation of Crosslinker Resin Solution

An alcohol blocked polyisocyanate crosslinking resin solution was prepared by charging 317.14 parts Mondur® MR (methylene diphenyl diisocyanate), 47.98 parts methylisobutyl ketone and 0.064 parts dibutyl tin dilaurate into a reaction vessel and heating to 37° C. under a dry nitrogen blanket. A mixture of 323.10 parts of diethylene glycol monobutyl ether and 13.04 parts of trimethylpropane was slowly charged into the reaction vessel while maintaining the reaction mixture below 93° C. The resulting mixture was held at 110° C. until all of the isocyanate was reacted as indicated by infra-red scan. 2.3 parts butanol and 167.37 parts methyl isobutyl ketone were added to the reaction mixture. The resulting resin solution had a nonvolatile content of 75%.

### Preparation of Chain Extended Polyepoxide Aqueous Emulsion

The following ingredients were charged into a reaction vessel: 1478 parts Epon® 828 (epoxy resin of diglycidyl ether of bisphenol A having an epoxy equivalent weight of 188); 427 parts bisphenol A; 533 parts Synfac® 8009 (ethoxylated bisphenol A having a hydroxyl equivalent weight of 247); 121 parts xylene and 2 parts dimethyl benzyl amine. The resulting reaction mixture was heated to 160° C. under a nitrogen blanket and held at this temperature for one hour. 5 parts dimethyl benzyl amine were added and the mixture was held at 147° C. until an epoxy equivalent weight of 1050 was reached. The reaction mixture was cooled to 149° C. and then 2061 parts of the above prepared crosslinker resin solution were added. When the reaction mixture temperature cooled to 107° C.,168 parts of diketimine and 143 parts of methyl ethanol amine were added. Diketimine is the reaction product of diethylene triamine and methyl isobutyl ketone having 73% nonvolatile content. The resulting mixture was held at 120° C. for one hour and then dispersed in an aqueous medium of 3886 parts deionized water and 182.6 parts lactic acid (88% lactic acid in deionized water). The mixture is further diluted with 2741 parts deionized water. The emulsion was kept agitated until the methyl isobutyl ketone evaporated. The resulting emulsion had a nonvolatile content of 38%.

### Preparation of Pigment Dispersion

The following constituents were charged into a suitable mixing container:

| | Dispersion I | Dispersion II |
|---|---|---|
| | Parts by | Parts by |
| | Weight | Weight |
| Novel Pigment Dispersant (prepared above) | 322.12 | — |
| A Conventional pigment Dispersant | — | 505.68 |
| (prepared above) | | |
| Deionized water | 1165.88 | 1447.24 |
| Titanium dioxide pigment | 595.88 | 352.07 |
| Aluminum silicate pigment | 365.60 | 277.36 |
| Carbon black pigment | 21.77 | 16.52 |
| Barium sulfate pigment | 332.19 | 252.01 |
| Dibutyl tin oxide | 196.56 | 149.12 |
| TOTAL | 3000.00 | 3000.00 |

The above ingredients were mixed until a homogeneous mixture was formed in a suitable mixer. The mixture was charged into an Eiger mill and then ground to a Hegman No. 7.

| | Parts by | Parts by |
|---|---|---|
| | Weight | Weight |
| | Bath I | Bath II |
| Chain Extended Polyepoxide Aqueous Emulsion | 1732.74 | 1701.5 |
| (prepared above) | | |
| Deionized Water | 1956.74 | 1922.47 |
| Pigment Dispersion I (prepared above) | 211.51 | — |
| Pigment Dispersion II (prepared above) | — | 278.80 |
| Anti Crater Agent* | 99.01 | 97.23 |
| TOTAL | 4000.00 | 4000.00 |

*A reaction product of Jeffamine ® 2000 polyoxpropylene diamine weight average molecular weight 2000, Huntsman Company and Epon ® 1001 diglycidyl ether of bispheol A having an epoxy equivalent weight of 500

The electrocoating bath I and II was prepared by mixing the above ingredients together and then the baths were ultrafiltered. The pH of the baths was adjusted to 6.0 to 6.05, the solid of the baths was 20%, and the bath's pigment to binder ratio was 15 to 100. Phosphated steel panels were electrocoated at 240-280 volts and coatings were obtained having a wet film thickness of 0.8-1.0 mils (20.32-25.4 microns). The panels were baked at 182° C. for 10 minutes to form a smooth film. The surface roughness of the cured film was measured by using a Taylor-Hobson Surtronic 3+ profilometer. The surface roughness was 10 in for bath I and 12 in for bath II. The bath's VOC (volatile organic compound) for bath I is 0.20 lbs/gal and for bath II is 0.40 lbs/gal. Bath I (containing the novel pigment dispersant) formed films that had less surface roughness and had a substantially lower VOC in comparison to Both II (containing a conventional pigment dispersant).

What is claimed is:

1. A pigment dispersant useful in a cathodic electrocoating composition comprising the reaction product of (1) an adduct of an alkyl aminoalkyl amine and an alkylene carbonate; and (2) an organic acid to form a tertiary amine salt and (3) an epoxy resin being reacted with the amine salt to form a quaternary ammonium salt.

2. The pigment dispersant of claim 1 in which the alkyl aminoalkyl amine and the alkylene carbonate are reacted in an approximate equal molar amount.

3. The pigment dispersant of claim 2 in which the alkylene carbonate is selected from the group consisting of a five-membered ring carbonate or six-membered ring carbonate.

4. The pigment dispersant of claim 3 in which the alkylene carbonate is propylene carbonate.

5. The pigment dispersant of claim 1 in which the alkyl aminoalkyl amine is an alkylaminopropyl amine.

6. The pigment dispersant of claim 5 in which the amine is dimethyl aminopropylamine.

7. The pigment dispersant of claim 1 in which the acid is an organic acid selected from the group consisting of lactic acid, acetic acid and formic acid.

8. The pigment dispersant of claim 7 in which the organic acid is lactic acid.

9. The pigment dispersant of claim 1 in which the epoxy resin is the diglycidyl ether of bisphenol A having an expoxide equivalent weight of 100 to 1,000.

10. The pigment dispersant of claim 1 in which the alkylene carbonate is propylene carbonate, the alkyl aminoalkyl amine is dimethylaminopropylamine, the organic acid is lactic acid, and the epoxy resin is the diglycidyl ether of bisplenol A having an epoxide equivalent weight of 100-1,000 acid wherein the alkyl aminoalkyl amine and the alkylene carbonate are reacted stoichemitrically.

11. A process for forming a pigment dispersant which comprises
reacting an alkylene aminoalkyl amine and an alkylene carbonate in equal molar amounts at about 75-100° C. for about 30 to 180 minutes to form an adduct,
reacting the adduct with an organic acid at about 75-115° C. for about 30-180 minutes to form a tertiary amine salt;
reacting the tertiary amine salt with an epoxy resin having an epoxide equivalent weight of about 100-1,000 at about 75-115° C. for about 30-180 minutes to form a quaternary ammonium salt.

12. An aqueous cathodic electrocoating composition comprising an epoxy amine resin, a blocked polyisocyanate crosslinking agent, pigment, and the pigment dispersant of claim 1.
